(19) United States
(12) Patent Application Publication
(10) Pub. No.: US 2011/0273385 A1
(43) Pub. Date: Nov. 10, 2011

(54) Sensing Structure and Method of Touch Spot of Resistive Touch Panel

(76) Inventors: CHIH-HSUAN LIAO, Kaohsiung City (TW); YU-HSIANG CHENG, Kaohsiung City, (TW); CHENG-HSUAN WANG, Kaohsiung City, (TW)

(21) Appl. No.: 13/045,508

(22) Filed: Mar. 10, 2011

(30) Foreign Application Priority Data
May 4, 2010 (TW) 099114290

(51) Int. Cl. G06F 3/041

(52) U.S. Cl. 345/173

(57) ABSTRACT

A sensing structure and method for a touch spot of a resistive touch panel, includes a first conducting layer, with a frame of the first conducting layer defined as an X-axis, a plurality of parallel first resistance detecting lines designed towards Y-axis; and a second conducting layer coincident with the first conductive layer, and a plurality of second resistance detecting lines with certain slope angles on the second conducting layer. The plural second resistance detecting lines intersect plural first resistance detecting lines to form interlacing and fixed blocks. In response to a screen touch, the position of the Y-axis of the second resistance detecting line is used in a triangulation calculation.

### BACKGROUND OF THE PRESENT INVENTION

1. Field of Invention

The present invention relates to a resistive touch panel, and particularly to the sensing structure and method of the touch spot of a resistive touch panel.

2. Description of Related Arts

The techniques of the touch screen are classified into different types which mainly include Resistive type (Film on Glass), Capacitive type, Ultrasonic type, Optical profile (infrared ray) type, etc. The main principle, taking the resistive touch panel as an example, is that a set of top and a set of bottom ITO (Indium Tin Oxide) conducting films, which have excellent electric conductivity, light transmission, and infrared ray reflectivity, coincide so pressure caused by touching the screen—using fingers or other the like—turns the top and bottom electrodes on. A controller can detect the change of panel pressure and calculate the position of the touch spot. Other sensors can detect voltage, electric current, sound wave or infrared ray, etc. to calculate the coordinate position of the touch spot.

As disclosed in Publication Number 200935290 “Resistive Touch Screen” a resistive touch screen, referring to FIG. 9, there is a plurality of detecting patterns which have a plurality of parallel resistance detecting lines (42) perpendicular to the X-axis provided on the top conductive layers (4), and there is a plurality of detecting patterns which having parallel resistance detecting lines (52) parallel to the X-axis on the bottom conductive layers (5). The two detecting patterns coincide in arrays. The resistance detecting patterns having plural parallel lines on the top conductive layers (4) and the resistive detecting patterns having plural parallel lines on the top conductive layers (5) are mutually perpendicular. The is voltage alternatively applied to the touched lines of the resistive detecting patterns on the top conductive layers (4) and the resistive detecting patterns on the bottom conductive layers (5) to obtain the X-axis and Y-axis. Although it can improve that one touch point is identified in a conventional case, and provide a touch screen capable of identifying a multi-touch which cannot be identified in the conventional resistive touch screen.

But because the resistive detecting patterns having plural parallel lines on the top conductive layers (4) and the resistive detecting patterns having plural parallel lines on the top conductive layers (5) are mutually perpendicular in a fixed array, so the definition and precision are problematic. On some touch screens with special requirements, some blocks need high accuracy, while other blocks don't, but the prior art is inflexible regarding this need.

### SUMMARY OF THE PRESENT INVENTION

A solution to the above problems is a sensing structure of the touch spot of a resistive touch panel: a first conducting layer with a frame defined as an X-axis, a plurality of parallel first resistance detecting lines, parallel or perpendicular to the X-axis, separate from the X-axis towards Y-axis. And the plural first resistance detecting lines are divided by a plurality of division lines perpendicular or parallel to the X-axis. The plural first resistance detecting lines are divided to form spacer blocks; an intermediate second conducting layer coincides with the first conducting layer, and there is a defining edge coinciding with the frame of the X-axis, and a hypothetical fiducial point. There is a plurality of second resistance detecting lines extended from the hypothetical fiducial point; each second resistance detecting line and the defining edge intersect to form angles with different degrees. The second resistance detecting lines intersect with the first resistance detecting lines and correspond to division lines on another conducting layer to form a interlacing and fixed blocks; a calculating unit: the second resistance detecting lines and first resistance detecting lines of the calculating unit intersect to form crossing points. There is a calculating process which executes: when touching the crossing point of any of the second resistance detecting lines and any of the first resistance detecting lines, the position of the Y-axis of any of the second resistance detecting lines is calculated through the position of any of the known first resistance detecting lines and the distance of the line segments from the X-axis to the hypothetical fiducial point for combining with the angle intersected between any of the second resistance detecting lines and the defining edge.

The present invention concerns not the mutually perpendicular array. Instead, plural second resistance detecting lines with slope angles and first resistance detecting lines mutually parallel with each other obliquely interlace. Therefore, the blocks so framed by the interlacement are different in size—unlike the prior art. When part of the touch screen requiring high precision can be distributed at the position of the relatively small framed blocks, and other parts do not require high precision, it can be distributed at the position of the relatively big framed blocks, so a flexible change of the touch screen is provided. Besides achieving the identification of the input of the multi-spots, a blanketing effect decreases the input precision.

### BRIEF DESCRIPTION OF THE DRAWINGS

FIG. 1 is a three-dimensional exploded view of the present invention.

FIG. 2 is a schematic of the present invention.

FIG. 3 is a schematic of a first conducting layer and coincident a second conducting layer according to the present invention.

FIG. 4 is a schematic view of an alternative embodiment of the first conducting layer and coincident second conducting layer according to the present invention.

FIG. 5 is a schematic of a third embodiment of the first conducting layer and the second conducting layer coincided together according to the present invention.

FIG. 6 is a schematic of a preferred operating fiducial point of the present invention.

FIG. 7 is a schematic of another operating fiducial point of the present invention.

FIG. 8 is an effective schematic of the first conducting layer and the second conducting layer under the conducting state according to the present invention.

FIG. 9 is a three-dimensional exploded view of a known multi-touch screen.

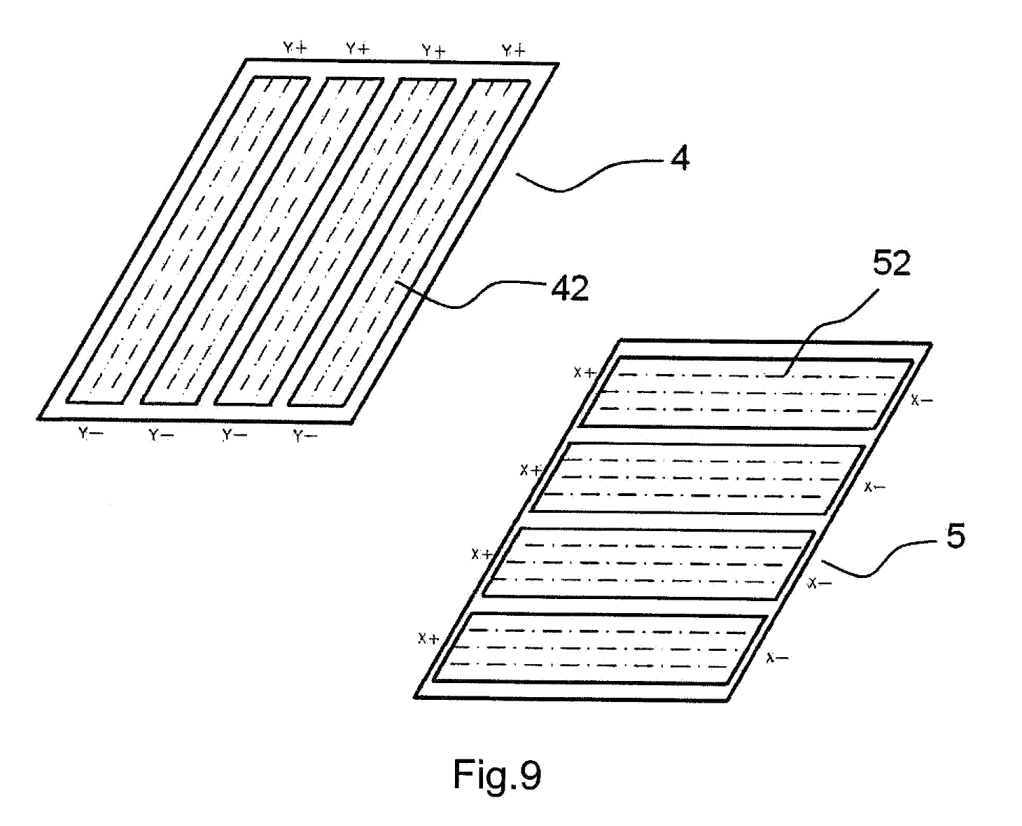

### DETAILED DESCRIPTION OF THE PREFERRED EMBODIMENT

The following describes the contents/characteristics and embodiments . . . .

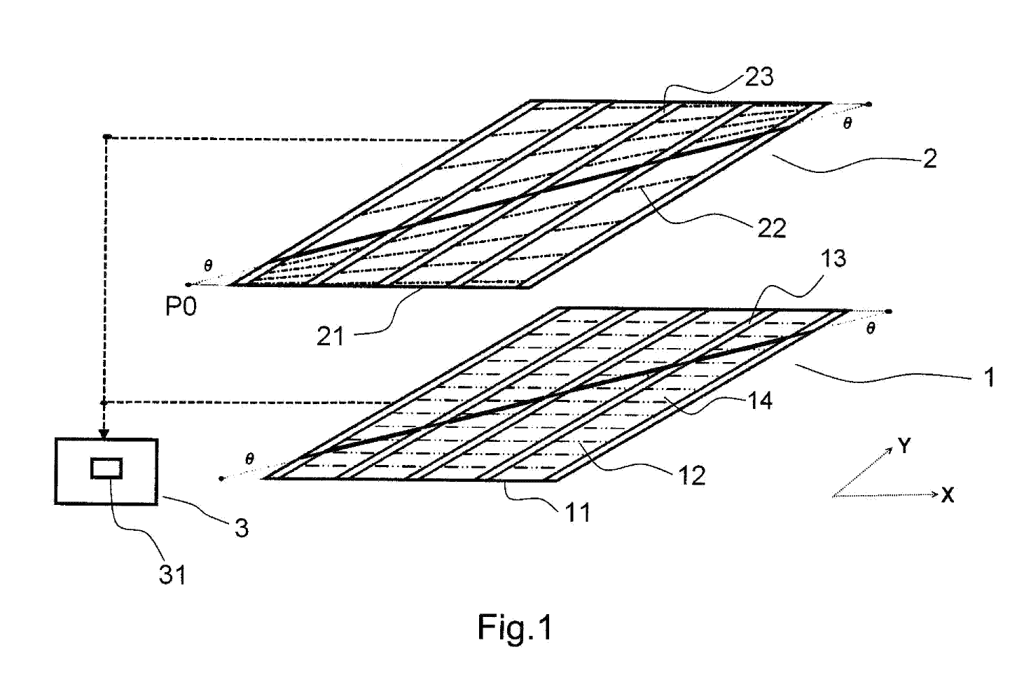

Referring to FIG. 1, the present invention relates to a sensing structure of the touch spot of a resistive touch panel, including:

a first conducting layer (1):

taking a frame defined as an X-axis (11), providing a plurality of parallel first resistance detecting lines (12) parallel or perpendicular to the X-axis (11), separately designed from the X-axis (11) towards Y-axis, as shown in FIG. 1, taking parallel to the X-axis (11) as an example. And the plural first resistance detecting lines (12) are divided by a plurality of division lines (13), perpendicular or parallel to the X-axis. As shown in FIG. 1, the plural division lines (13) which are perpendicular to the X-axis divide the plural first resistance detecting lines (12). And a plurality of spacer blocks (14) is formed. The spacer blocks (14) block interlocking of the plural first resistance detecting lines (12), so pressing or touching can be limited as to the scope of the spacer blocks (14). The plural first resistance detecting lines (12) are divided by the division lines (13) to avoid the interlinking so as to obtain more pressing or touching sense (multi-touch).

a second conducting layer (2):

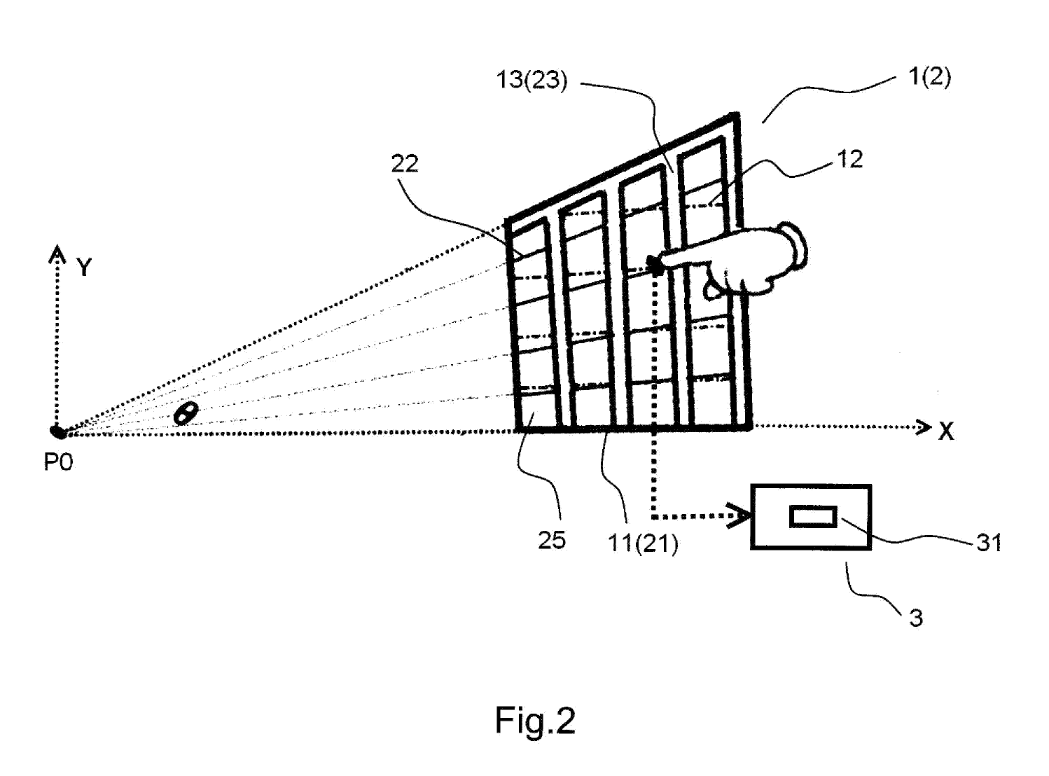

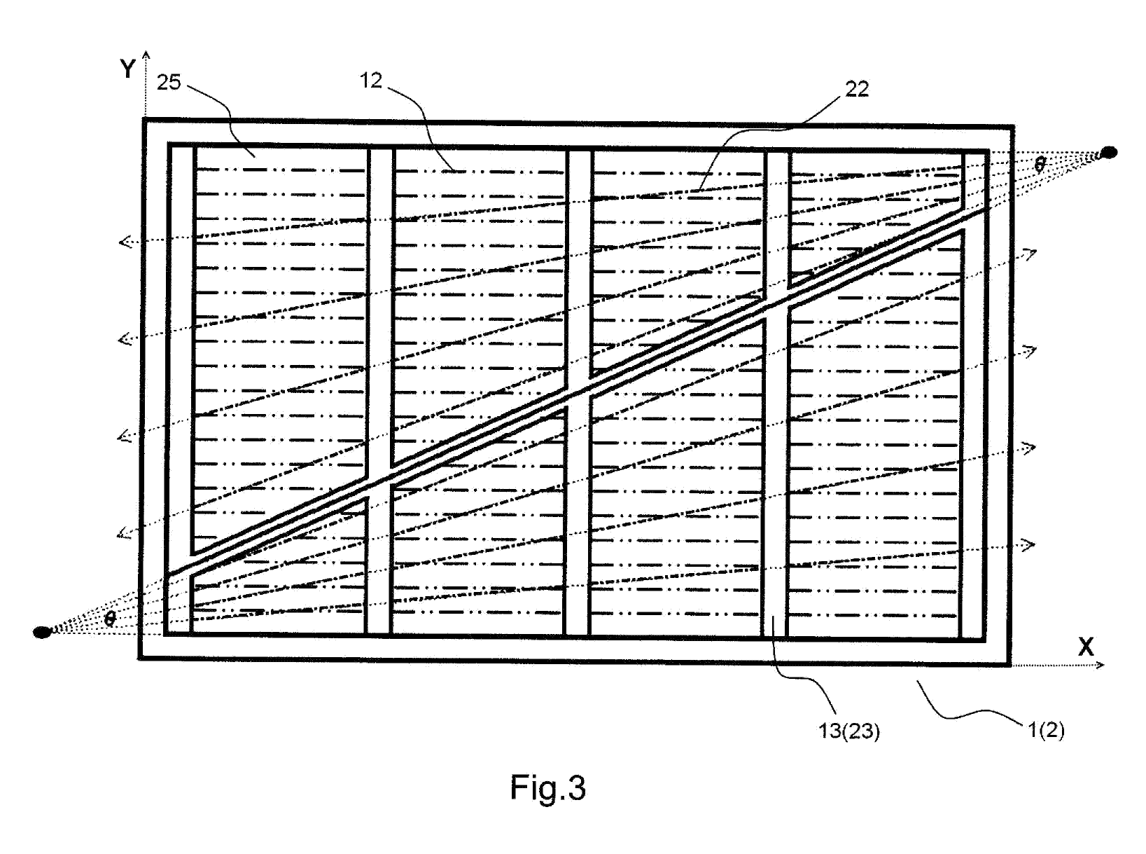

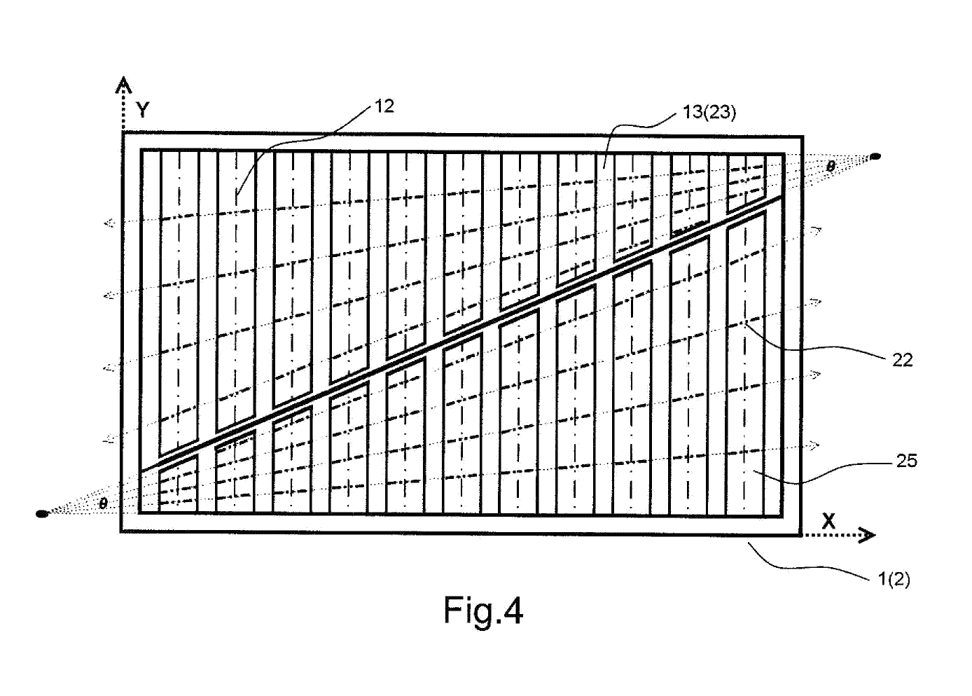

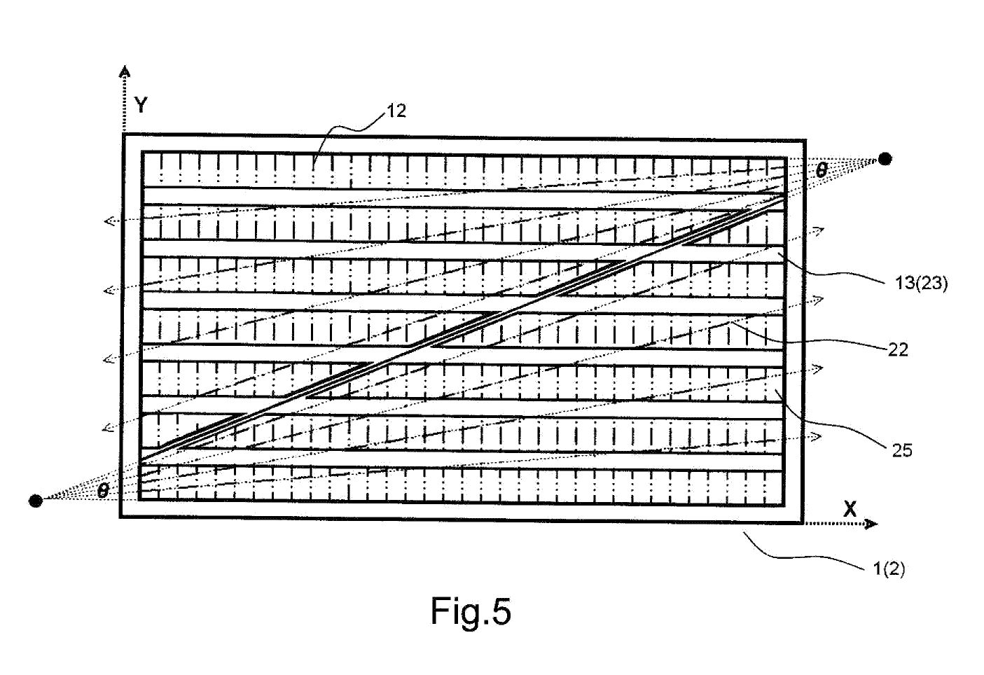

coincident with the first conducting layer (1), with a defining edge (21) coincident with the frame of the X-axis (11). And there is a hypothetical fiducial point (P0). There is a plurality of second resistance detecting lines (22) extended from the hypothetical fiducial point (P0). Each second resistance detecting line (22) and defining edge (21) intersect to form angles with different degrees, as shown in FIGS. 2, 3, 4 and 5. The plural second resistance detecting lines (22) intersect with the plural first resistance detecting lines (12) corresponding to the division lines (23) on another conducting layer so as to form a plurality of interlacing and fixed blocks (25). The blocks (25) mainly formed by the plural second resistance detecting lines (22) intersecting the plural first resistance detecting lines (12) are form the frames of the triangles, and triangulating.

a calculating unit (3):

Referring to FIG. 2, the plural second resistance detecting lines (22) and the plural first resistance detecting lines (12) of the calculating unit (3) intersect to form crossing points. There is a calculating process (31): when touching the crossing point of any of the second resistance detecting lines (22) and any of the first resistance detecting lines (12), the position of the Y-axis of any of the second resistance detecting lines is calculated through the position of any of the known first resistance detecting lines (12) and the distance of the line segments from the X-axis to the hypothetical fiducial point (P0) and combining with angle θ intersected between any of the second resistance detecting lines (22) and the defining edge (21). Wherein the first conducting layer (1) can be a conducting layer coincided at the lower layer or at the upper layer, the second conducting layer (2) can be a conducting layer coincided at the upper layer or at the lower layer.

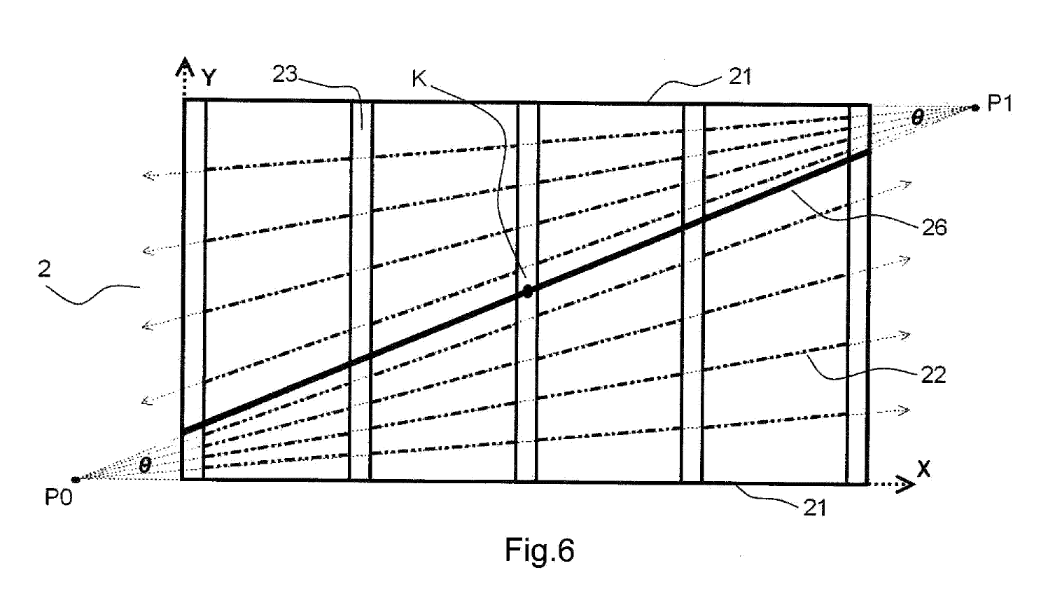

FIG. 6 shows finding out the centre-point (K) in the working area provided on the panel. And a fiducial point designed line (26) is not parallel to the X-axis and passes through the centre-point (K). The fiducial point designed line (26) intersects the two defining edges (21) in the main working area on the panel for calculating the two fiducial point (P0) (P1) to form two same corresponding included angle θ, so that the distribution of the second resistance detecting lines (22) on the second conductive layer (2) can be conveniently set using the two fiducial point (P0) (P1).

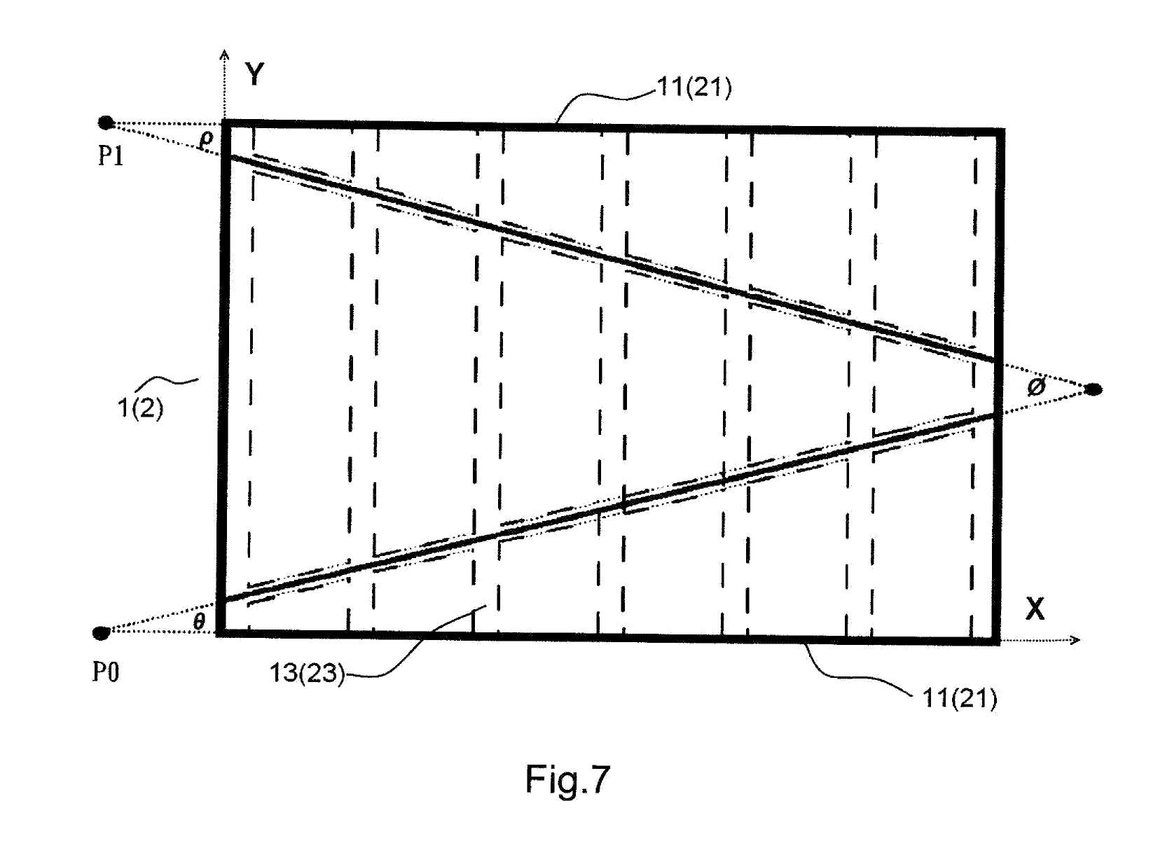

Referring to FIG. 7, the fiducial point (P0) of the present invention can also be the different position of the embodiment P1 shown in the FIG., and there also can be a frame edge coincident with the X-axis as a defining edge (21) to get an angle ρ to calculate the position of the Y-axis of any of the second resistance detecting lines (22).

Based on the same invention, the sensing method of the touch spot of the resistive touch panel is subsequently coincident from top to bottom:

a first conducting layer (1):

taking a frame defined as an X-axis (11), there is a plurality of parallel first resistance detecting lines (12) parallel or perpendicular to the X-axis designed from the X-axis towards Y-axis, as shown in FIG. 1, taking parallel to the X-axis (11) as an example. And the plural first resistance detecting lines (12) are divided by a plurality of division lines (13) which are perpendicular or parallel to the X-axis. As shown in FIG. 1, the plural division lines (13) which are perpendicular to the X-axis divide the plural first resistance detecting lines (12). And spacer blocks (14) are formed. The spacer blocks (14) block interlocking of the plural first resistance detecting lines (12), so pressing or touching can be limited as to the scope of the spacer blocks (14) to avoid interlinking and obtain more pressing or touching sense (multi-touch).

a second conducting layer (2):

coincident with the first conducting layer (1), and a defining edge (21) coincident with the frame of the X-axis (11). And there is a hypothetical fiducial point (P0). There is a plurality of second resistance detecting lines (22) extended from the hypothetical fiducial point (P0). Each second resistance detecting line (22) and the defining edge (21) intersect each other to form a plurality of angles with different degrees, as shown in FIGS. 2, 3, 4 and 5. The plural second resistance detecting lines (22) intersect with the plural first resistance detecting lines (12) and through corresponding to the division lines (23) on another conducting layer to form a plurality of interlacing and fixed blocks (25). The difference of the wording of the “blocks” (25) and the “spacer blocks” (14) is mainly used to distinguish each other. The blocks (25) formed by the plural second resistance detecting lines (22) intersecting the plural first resistance detecting lines (12) are form the frames of the triangles, and then used to triangulate.

To steps, when touching at the crossing point of any of the second resistance detecting lines (22) and any of the first resistance detecting lines (12), the position of the Y-axis of any of the second resistance detecting lines is calculated through the calculating unit (3) of the calculating process (31) and through the position of any of the known first resistance detecting lines (12) and the distance of the line segments from the X-axis to the hypothetical fiducial point (P0) for combining with the angle θ intersected between any of the second resistance detecting lines (22) and the defining edge (21). Wherein the first conducting layer (1) can be a conducting layer coincided at the lower layer or at the upper layer, the second conducting layer (2) can be a conducting layer coincided at the upper layer or at the lower layer.

FIG. 6 is a schematic view of a preferred operating fiducial point of the present invention. First, the centre-point (K) is determined within the working area provided on the panel. And there is provided a fiducial point designed line (26) not parallel to the X-axis and passes through the centre-point (K). The fiducial point designed line (26) intersects the two defining edges (21) in the main working area on the panel to calculate the two fiducial point (P0) (P1) to form two same corresponding included angle θ, so that the distribution of the second resistance detecting lines (22) on the second conductive layer (2) can be conveniently set using the two fiducial point (P0) (P1).

Referring to FIG. 7, the fiducial point (P0) of the present invention can also be the different position of the embodiment P1 shown in the FIG., and there also can be a frame edge coincided to the X-axis as a defining edge (21) to get an angle ρ to calculate the position of the Y-axis of any of the second resistance detecting lines (22).

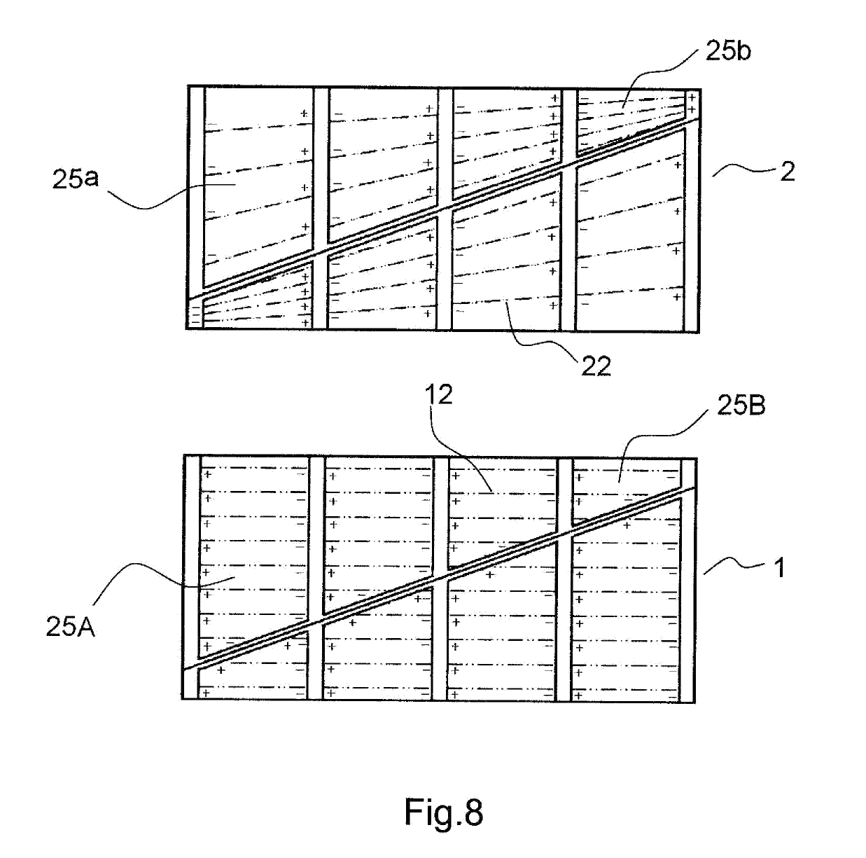

FIG. 8 is a schematic view of the first conducting layer and the second conducting layer applied under the conducting state according to the present invention. The present invention does not apply ┌mutually perpendicular┘ but the plural second resistance detecting lines (22) with certain slope angles and the first resistance detecting lines (12) mutually parallel with each other to apply relatively oblique interlacement, so the blocks (25A) (25a) (25B) (25b) framed by the interlacement are different in size, so that the distribution of the precision is different from the thinking strategy of the known technology to elastically dispatch and change the definition and precision. When part of the touch screen requiring high precision, it can be distributed at the position of the relatively small framed blocks (25B) (25b), and when other parts do not require high precision, it can be distributed at the position of the relatively big framed blocks (25A) (25a), so that the flexible change of the touch screen can be provided and the decreasing of the input precision can be decreased because of the blanketing effect.

Overall, the present invention accords with the requirements of the patentability, so the application was filed according to law. The above description is a preferred embodiment according to the present invention. All of the equivalent change according to the scope of the claims according to the present invention all belongs to the scope of the objects of the application.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A sensing structure of a touch spot of a resistive touch panel, including:
a first conducting layer having a frame defined with an X-axis, a plurality of parallel first resistance detecting lines parallel or perpendicular to said X-axis separately provided from said X-axis towards said Y-axis, and a plurality of division lines dividing said first resistance detecting lines to form a plurality of spacer blocks;
a second conducting layer coincident with said first conducting layer with a defining edge coincident with said frame of said X-axis, a plurality of second resistance detecting lines being extended from a hypothetical fiducial point, said second resistance detecting lines and said defining edge intersecting to form a plurality of angles with different degrees forming a plurality of interlacing and fixed blocks corresponding to said division lines on said first conducting layer; and
a calculating unit, wherein crossing points are formed through instersection of said calculating unit, said second resistance detecting lines and said first resistance detecting lines, wherein said calculating unit executes that in responsive to touching said crossing point of a position of said Y-axis of any of said second resistance detecting lines is calculated through a position of any of said known first resistance detecting lines and a distance of line segments from said X-axis to said hypothetical fiducial point and through an angle between any of said second resistance detecting lines and said defining edge.

2. The sensing structure, as recited in claim 1, wherein said division lines are perpendicular to said X-axis.

3. The sensing structure, as recited in claim 1, wherein said division lines are parallel to said X-axis.

4. The sensing structure, as recited in claim 1, wherein said first conducting layer is a conducting layer coincident with a lower layer, and said second conducting layer is a conducting layer coincident with an upper layer.

5. The sensing structure, as recited in claim 2, wherein said first conducting layer is a conducting layer coincident with a lower layer, and said second conducting layer is a conducting layer coincident with an upper layer.

6. The sensing structure, as recited in claim 3, wherein said first conducting layer is a conducting layer coincident with a lower layer, and said second conducting layer is a conducting layer coincident with an upper layer.

7. The sensing structure, as recited in claim 1, wherein said first conducting layer is a conducting layer coincident with an upper layer, and said second conducting layer is a conducting layer coincident with a lower layer.

8. The sensing structure, as recited in claim 2, wherein said first conducting layer is a conducting layer coincident with an upper layer, and said second conducting layer is a conducting layer coincident with a lower layer.

9. The sensing structure, as recited in claim 3, wherein said first conducting layer is a conducting layer coincident with an upper layer, and said second conducting layer is a conducting layer coincident with a lower layer.

10. A sensing method of a touch spot of a resistive touch panel, comprising a step of providing subsequently coincident from top to bottom:
a first conducting layer having a frame with an X-axis, a plurality of parallel first resistance detecting lines, parallel or perpendicular to said X-axis, separately provided from said X-axis towards Y-axis, a plurality of division lines, perpendicular or parallel to said X-axis, dividing said plural first resistance detecting lines to form a plurality of spacer blocks;
a second conducting layer being coincident with said first conducting layer with a defining edge coincident with said frame of said X-axis, a plurality of second resistance detecting lines being extended from a hypothetical fiducial point, said second resistance detecting lines and said defining edge intersecting to form a plurality of angles with different degrees forming a plurality of interlacing and fixed blocks corresponding to said division lines on said first conducting layer; and
a calculating unit for executing a calculating process in response to touching said crossing point of any of said second resistance detecting lines and any of said first resistance detecting lines, wherein a position of said Y-axis of any of said second resistance detecting lines is calculated through a position of any of said known first resistance detecting lines and a distance of line segments from said X-axis to a hypothetical fiducial point and combining with an angle between any of said second resistance detecting lines and said defining edge.

11. The sensing method, as recited in claim 10, said division lines are perpendicular to said X-axis.

12. The sensing method, as recited in claim 10, said division lines are parallel to said X-axis.

13. The sensing method, as recited in claim 10, wherein said second conducting layer further contains said hypothetical fiducial point from which said second resistance detecting lines extended.

14. The sensing method, as recited in claim 11, wherein said second conducting layer further contains said hypothetical fiducial point from which said second resistance detecting lines extended.

15. The sensing method, as recited in claim 12, wherein said second conducting layer further contains said hypothetical fiducial point from which said second resistance detecting lines extended.

16. The sensing method, as recited in claim 10, wherein said first conducting layer is a conducting layer coincided at a lower layer, and said second conducting layer is a conducting layer coincided at an upper layer.

17. The sensing method, as recited in claim 10, wherein said first conducting layer is a conducting layer coincided at an upper layer, and said second conducting layer is a conducting layer coincided at a lower layer.

18. The sensing method, as recited in claim 13, wherein said first conducting layer is a conducting layer coincided at a lower layer, and said second conducting layer is a conducting layer coincided at an upper layer.

19. The sensing method, as recited in claim 13, wherein said first conducting layer is a conducting layer coincided at an upper layer, and said second conducting layer is a conducting layer coincided at a lower layer.
